(19) United States
(12) Patent Application Publication
(10) Pub. No.: US 2013/0101860 A1
(43) Pub. Date: Apr. 25, 2013

(54) METHOD FOR JOINING ALUMINUM PART AND RESIN AND COMPOSITE MADE BY SAME

(71) Applicants: SHU-XIANG ZHOU, Shenzhen City (CN); QIU-JIANG XU, Shenzhen City (CN); HONG-LIANG WANG, Shenzhen City (CN)

(72) Inventors: SHU-XIANG ZHOU, Shenzhen City (CN); QIU-JIANG XU, Shenzhen City (CN); HONG-LIANG WANG, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/419,573

(22) Filed: Mar. 14, 2012

(30) Foreign Application Priority Data
Oct. 21, 2011 (CN) 201110322709.X

(51) Int. Cl. B32B 9/04; B29C 45/14

(52) U.S. Cl. 428/447; 156/245

(57) ABSTRACT

A method for joining an aluminum part and resin, includes: providing an aluminum part made of aluminum or aluminum alloy; forming a bonding layer on a surface of the aluminum part by coating a liquid film of hydrolyzed silane coupling agent and drying the liquid film; forming an adhesive layer formed of polyurethane adhesive on the bonding layer and curing the adhesive layer; molding a resin part integrally bonded to the adhesive layer.

### BACKGROUND

1. Technical Field

The present disclosure relates to a method for joining aluminum parts and resin and aluminum-resin composites made by the method.

2. Description of Related Art

A typical method for joining metal parts (such as aluminum alloy parts) and resin includes coating a heat-sensitive adhesive layer on surfaces of the metal parts. Then, the resin is injected to bond with the surfaces having the adhesive layer of the metal parts by insert molding. However, due to having high chemical activity, surfaces of the aluminum parts are easily oxidized to form oxide aluminum films. The oxide aluminum films have a relatively low chemical activity, resisting joining with the resin. Thus, the bonding strength between the aluminum part and the molded resin is low.

Therefore, there is room for improvement within the art.

### BRIEF DESCRIPTION OF THE FIGURES

Many aspects of the disclosure can be better understood with reference to the following figures. The components in the figures are not necessarily drawn to scale, the emphasis instead being placed upon clearly illustrating the principles of the disclosure. Moreover, in the drawings like reference numerals designate corresponding parts throughout the several views.

FIG. 1 is a block diagram of a process for joining an aluminum part and resin.

FIG. 2 is a cross-sectional schematic view of an exemplary embodiment of an aluminum-resin composite made by the present method.

### DETAILED DESCRIPTION

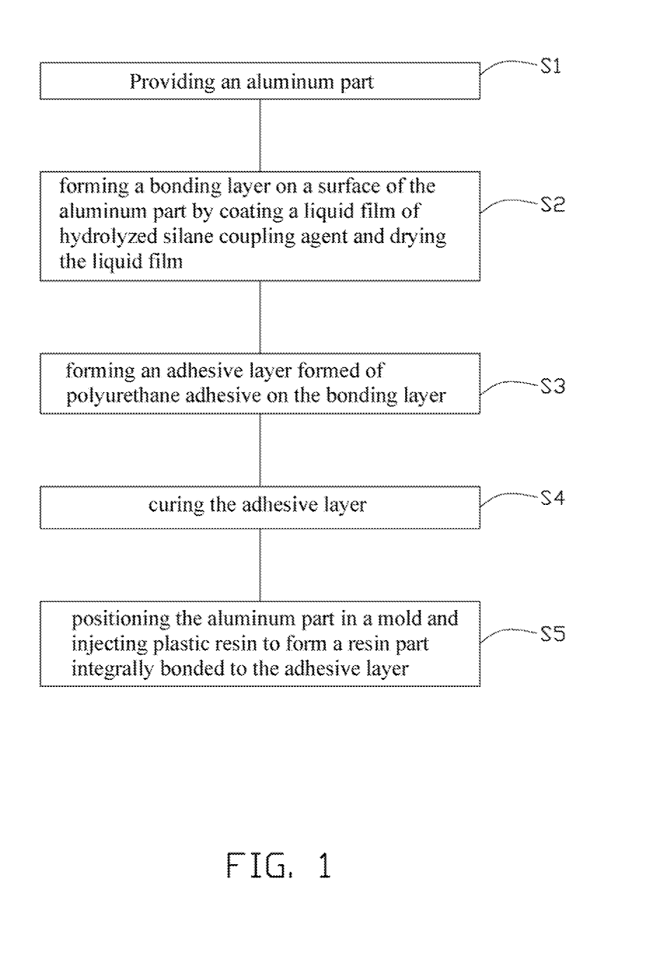

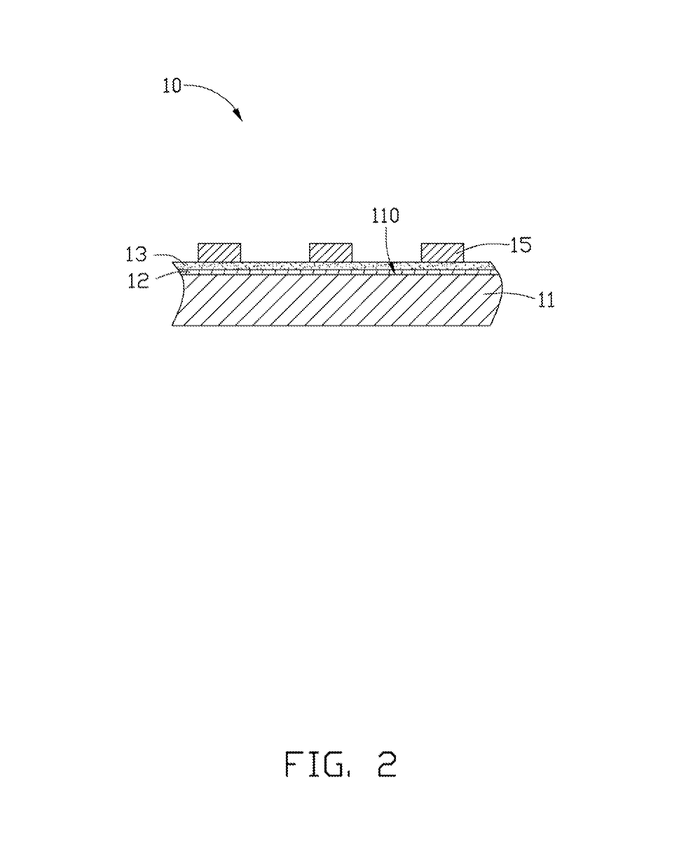

Referring to FIGS. 1 and 2, a method for joining an aluminum part and resin may include the following steps S1 to S4:

In step S1, an aluminum part 11 formed of aluminum or aluminum alloy is provided. The aluminum part 11 may be formed by punching and have a desired shape.

In step S2, the aluminum part 11 is pretreated. The pretreatment may be carried out by coating a liquid film of hydrolyzed silane coupling agent on a surface 110 of the aluminum part 11. Then the liquid film is dried and solidified, forming a bonding layer 12. The hydrolyzed silane coupling agent may be prepared by blending a silane coupling agent containing epoxy groups and alcohol (such as industrial alcohol) having a concentration of about 95 weight percent, with the silane coupling agent having a mass percentage of about 1% to about 6%. Then, the silane coupling agent and the alcohol may be stirred to obtain a uniform mixture. The mixture may be maintained static until the silane coupling agent is fully hydrolyzed. It may take about 25 minutes to about 35 minutes for full hydrolysis of the silane coupling agent. The silane coupling agent may be represented by the following chemical formula:

R′—Si—R₃

wherein R is an alkoxyl having 1 to 5 carbon atoms. The subscript ‘3’ is the number of R. R′ is an alkyl having an epoxy group. The R′ may be an alkyl having a 3,4-epoxy-cyclohexyl group. Accordingly, the silane coupling agent may be 2-(3,4-epoxy-cyclohexyl) ethyltrimethoxysilane, 3-(3,4-epoxy-cyclohexyl) propyltrimethoxysilane, or 4-(3,4-epoxy-cyclohexyl) butyltrimethoxysilane, for example. In the embodiment, the silane coupling agent is 2-(3,4-epoxy-cyclohexyl) ethyltrimethoxysilane.

After being hydrolyzed, the three alkoxyl groups are hydrolyzed to be three hydroxyl groups. Each molecule of the silane coupling agent has three hydroxyl groups after being hydrolyzed. Hydrolysis catalyst, such as a modified platinum catalyst may be added into the mixture, accelerating the hydrolysis of the silane coupling agent.

The hydrolyzed silane coupling agent is uniformly coated on the surface 110 of the aluminum part 11 by, for example spraying, forming the liquid film thereon. The aluminum part 11 having the liquid film may be dried under a temperature of about 100° C. to about 120° C. for about 4 minutes to about 8 minutes. The liquid film fully reacts with the aluminum part 11 and forms the bonding layer 12 when dried. During the drying, the hydroxyl groups of the hydrolyzed silane coupling agent react with hydroxyl groups existing on the surface 110 of the aluminum part 11, forming dense Si—O—M (M represents a metal atom) bonds dispersed on the surface 110 of the aluminum part 11. The bonding layer 12 bonds the aluminum part 11 via the Si—O—M bonds.

In step S3, after being cooled, the pretreated aluminum part 11 with the bonding layer 12 may be coated with an adhesive layer 13. The adhesive layer 13 may be directly formed on the bonding layer 12. The adhesive layer 13 may be formed of polyurethane adhesive which has urethane (—NHCOO—) groups within its molecular chains.

In step S4, the adhesive layer 13 may be cured. During the curing process, active groups (such as epoxy groups) on molecular chains of the bonding layer 12 may react with active groups (such as urethane groups) within the adhesive layer 13, thereby bonding the adhesive layer 13 and the aluminum part 11 via inter-molecular forces. The inter-molecular forces provide a strong bonding strength between the adhesive layer 13 and the aluminum part 11.

In step S5, the aluminum part 11 having the bonding layer 12 and the adhesive layer 13 is located in a injection mold (not shown), and molten resin is injected into the injection mold to cover and bond the adhesive layer 13, and finally form resin parts 15 when hardened. As such, an aluminum-resin composite 10 is formed. The molten resin may be thermoplastic resin, such as polyphenylene sulfide (PPS), polyamide (PA), or polyethylene terephthalate (PET).

Proved by experiments, with other factors unchanged, when the hydrolyzed silane coupling agent is prepared by mixing the alcohol and the silane coupling agent with the silane coupling agent under a mass percentage of about 3%, the obtained aluminum-resin composite 10 has the largest bonding strength between the aluminum part 11 and the resin parts 15. When the hydrolyzed silane coupling agent is prepared by mixing the alcohol and the silane coupling agent with the silane coupling agent having a mass percentage more than about 6%, the bonding strength between the aluminum part 11 and the resin parts 15 decreases about 20% to about 30% relative to the largest bonding strength.

The composite 10 manufactured by the present process can resist a drawing force of more than 200 N.

The method for joining an aluminum part and resin may further include degreasing the aluminum part 11 before the pretreatment step.

Referring to FIG. 2, the composite 10 manufactured by the present process includes the aluminum part 11 having a desired shape, the bonding layer 12 formed on the aluminum part 11, the adhesive layer 13 formed on the bonding layer 12, and the resin parts 15 integrally bonded to the adhesive layer 13.

The bonding layer 12 is formed by coating a liquid film of hydrolyzed silane coupling agent on the surface 110 of the aluminum part 11 and drying the liquid film. The bonding layer 12 bonds the the aluminum part 11 through Si—O—M (M represents a metal atom) bonds. The silane coupling agent may be represented by the chemical formula of R′—Si—R₃, wherein R is an alkoxyl having 1 to 5 carbon atoms. The subscript ‘3’ is the number of R. R′ is an alkyl having an epoxy group. The adhesive layer 13 is formed of polyurethane adhesive.

The resin parts 15 are formed by injection molding. The resin parts 15 may be formed of thermoplastic resin, such as PPS, PA, or PET.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. A method for joining an aluminum part and resin, comprising:
providing an aluminum part made of aluminum or aluminum alloy;
forming a bonding layer on a surface of the aluminum part by coating a liquid film of hydrolyzed silane coupling agent on the surface of the aluminum part and drying the liquid film;
forming an adhesive layer formed of polyurethane adhesive on the bonding layer;
curing the adhesive layer;
positioning the aluminum part having the bonding layer and the adhesive layer in a injection mold; and
injecting thermoplastic resin on the adhesive layer to form a resin part integrally bonded to the adhesive layer when hardened.

2. The method as claimed in claim 1, wherein hydrolyzed silane coupling agent is prepared by blending a silane coupling agent containing epoxy groups and alcohol having a concentration of about 95 weight percent to obtain a mixture, with the silane coupling agent having a mass percentage of about 1% to about 6%, and maintaining the mixture static until the silane coupling agent is fully hydrolyzed.

3. The method as claimed in claim 2, wherein the mixture is maintained static for about 25 minutes to about 35 minutes.

4. The method as claimed in claim 2, wherein silane coupling agent is represented by the chemical formula of R′—Si—R₃, wherein R is an alkoxyl having 1 to 5 carbon atoms, R′ is an alkyl having an epoxy group.

5. The method as claimed in claim 4, wherein the R′ is an alkyl having a 3,4-epoxy-cyclohexyl group.

6. The method as claimed in claim 5, wherein the silane coupling agent is one selected from a group consisting of 2-(3,4-epoxy-cyclohexyl) ethyltrimethoxysilane, 3-(3,4-epoxy-cyclohexyl) propyltrimethoxysilane, or 4-(3,4-epoxy-cyclohexyl) butyltrimethoxysilane.

7. The method as claimed in claim 2, wherein the silane coupling agent has a mass percentage of about 1% to about 6% within the mixture.

8. The method as claimed in claim 2, wherein the step of drying the liquid film is carried out under a temperature of about 100° C. to about 120° C. for about 4 minutes to about 8 minutes.

9. The method as claimed in claim 2, wherein during the step of drying the liquid film, the hydrolyzed silane coupling agent react with hydroxyl groups existing on the surface of the aluminum part, forming dense Si—O—M bonds dispersed on the surface of the aluminum part, wherein M represents a metal atom.

10. The method as claimed in claim 9, wherein the bonding layer bonds the aluminum part via the Si—O—M bonds.

11. The method as claimed in claim 2, wherein during the step of curing the adhesive layer, epoxy groups of the bonding layer react with urethane groups of the adhesive layer.

12. An aluminum-resin composite, comprising:
an aluminum part made of aluminum or aluminum alloy;
a bonding layer formed on a surface of the aluminum part, the bonding layer formed by coating a liquid film of hydrolyzed silane coupling agent on the surface of the aluminum part and drying the liquid film;
an adhesive layer formed on the bonding layer, the adhesive layer formed of polyurethane adhesive; and
a resin part integrally bonded to the adhesive layer.

13. The composite as claimed in claim 12, wherein the silane coupling agent is represented by the chemical formula of R′—Si—R₃, R is an alkoxyl having 1 to 5 carbon atoms, R′ is an alkyl having an epoxy group.

14. The composite as claimed in claim 12, wherein the bonding layer bonds the aluminum part via Si—O—M bonds, M represents a metal atom.

15. The composite as claimed in claim 12, wherein the R′ is an alkyl having a 3,4-epoxy-cyclohexyl group.

16. The composite as claimed in claim 12, wherein the resin part is formed of thermoplastic resin.
